(19) United States
(12) Patent Application Publication
(10) Pub. No.: US 2007/0215595 A1
(43) Pub. Date: Sep. 20, 2007

(54) Steaming structure for a steam oven

(76) Inventor: Ching-Hsiang Wang, Tainan City (TW)

Correspondence Address: Ching-Hsiang WANG, P.O. Box 90, Tainan City, 70499, TW

(21) Appl. No.: 11/376,214

(22) Filed: Mar. 16, 2006

(51) Int. Cl. F27D 11/00

(52) U.S. Cl. 219/401

(57) ABSTRACT

A steaming structure for a steam oven includes a housing having an accommodating groove and a draining hole communicating with each other. The accommodating groove has a connecting pipe connected with a water-pumping motor connected with a duct, which is connected with a water-feeding pipe positioned in the housing. An electric heating tray with a center hollow is installed below the water-feeding pipe. A regulating device is connected with an exhaust passageway of the housing having an exhaust hole. A holding tray with two accommodating chambers is placed in the accommodating groove of the housing. A water tank is received in one of the accommodating chambers. A cover plate is covered on the holding tray, having an insert hole aligned to the draining hole of the housing and located on the accommodating chamber.

### BACKGROUND OF THE INVENTION

1. Field of the Invention

This invention relates to a steaming structure for a steam oven, particularly to one able to steam food by steam heat to prevent steamed food from becoming dry and hard.

2. Description of the Prior Art

A conventional oven is provided inside with an electric heating tube to produce heat energy for roasting food. However, when food is roasted in this way, the roasted food may lose its moisture and become dry and hard with poor taste. To prevent food from becoming dry after roasted, the surface of food has to be sprinkled with a little quantity of water before the food is placed in the oven to be roasted; nevertheless, if water sprinkled on the surface of the food is too much or uneven, the roasted portion of the food may become soft and tasteless.

### SUMMARY OF THE INVENTION

The objective of this invention is to offer a steaming structure for a steam oven, able to steam food with steam heat to prevent food from being roasted dry and hard and make the steamed food much tasty.

The steaming structure for a steam oven in the present invention includes a housing formed with an accommodating groove in the bottom. The housing is bored with a draining hole communicating with the accommodating groove, which has its inner wall provided with a connecting pipe connected with a water-pumping motor. The water-pumping motor has the other end connected with a duct, which has the other end connected with a water feeding pipe positioned in the housing. An electric heating tray is installed below the water-feeding pipe in the housing and formed with a center hollow. The housing has its inner upper side provided with an exhaust passageway having one end connected with a regulating device and further its topside bored with an exhaust hole. A holding tray is received in the accommodating groove of the housing and formed inside with two accommodating chambers, and a water tank is placed in one of the two accommodating chambers. The water tank has its upper side bored with an inflow hole and its rear side bored with an outflow hole fitted with a sleeve to be connected with the connecting pipe of the accommodating groove of the housing.

### BRIEF DESCRIPTION OF DRAWINGS

This invention will be better understood by referring to the accompanying drawings, wherein:

FIG. 1 is a partial exploded perspective view of a steaming structure for a steam oven in the present invention;

FIG. 2 is a side cross-sectional view of the steaming structure for a steam oven in the present invention;

FIG. 3 is an exploded perspective view of a regulating device of the steaming structure for a steam oven in the present invention;

FIG. 4 is a front view of the regulating device having its through hole completely opened in the present invention; and

FIG. 5 is a front view of the regulating device having its through hole regulated in the present invention.

### DETAILED DESCRIPTION OF THE PREFERRED EMBODIMENT

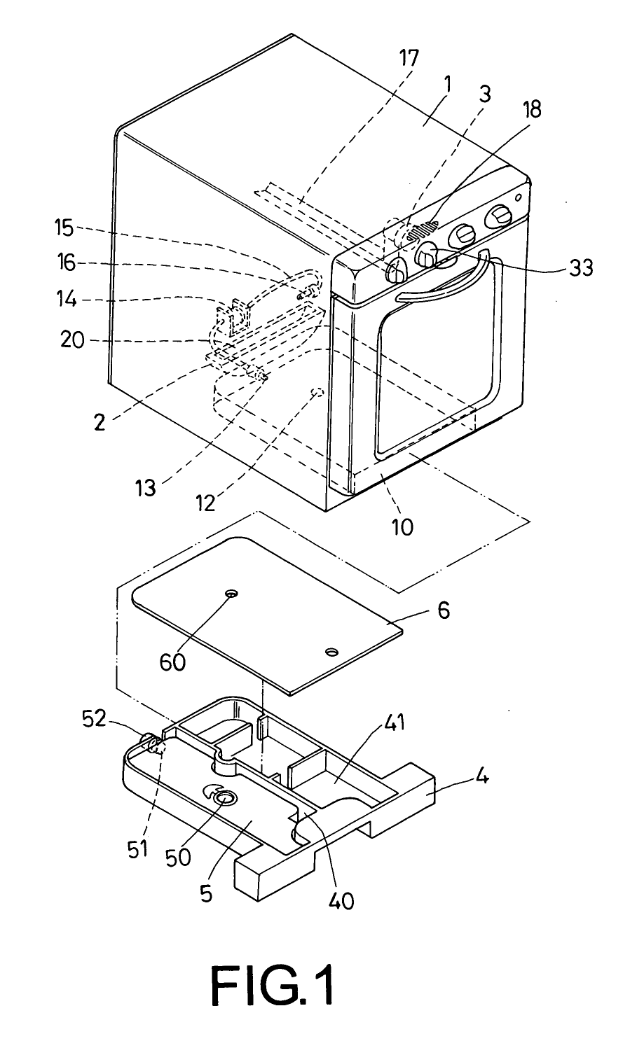

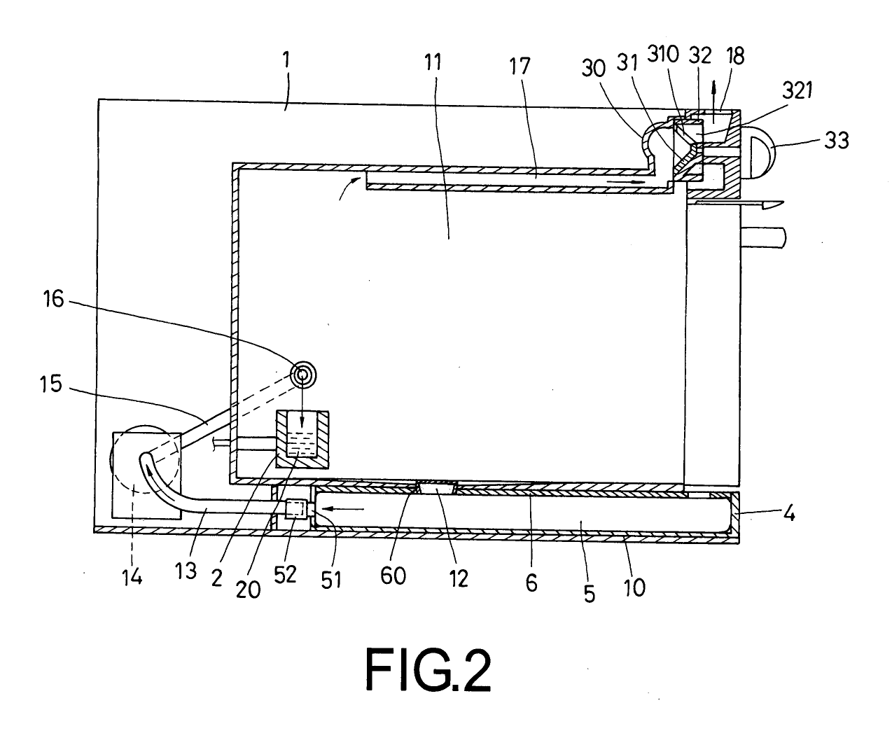

A preferred embodiment of a steaming structure for a steam oven in the present invention, as shown in FIGS. 1 and 2, includes a housing 1, an electric heating tray 2, a regulating device 3, a holding tray 4, a water tank 5 and a cover plate 6 as main components combined together.

The housing 1 is provided with an accommodating groove 10 at the bottom and a draining hole 12 bored in the bottom wall and communicating with the accommodating groove 10. The accommodating groove 10 has its inner wall fixed with a connecting pipe 13 connected with a water pumping motor 14, which has the other end connected with a duct 15 having the other end connected with a water feeding pipe 16 positioned in the oven interior 11.

The electric heating tray 2 is installed below the water-feeding pipe 16 in the roaster oven interior 11 and formed with a center hollow 20.

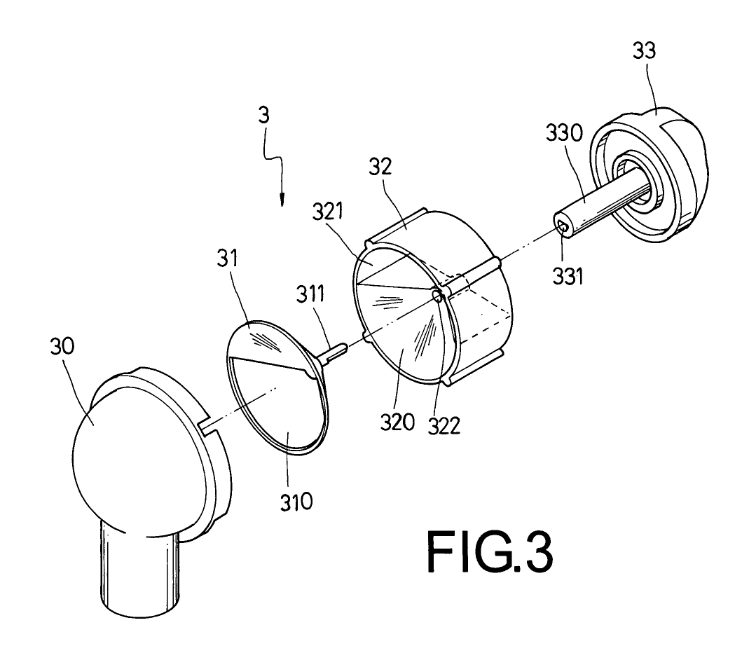

The regulating device 3 connected with an exhaust passageway 17 at the upper inner side of the housing 1 is composed of a connecting base 30, a blocking member 31, a fixing base 32 and a regulating button 33, as shown in FIG. 3. The connecting base 30 is connected with one end of the exhaust passageway 17, and the fixing base 32 is assembled at one side of the connecting base 30 and formed with an accommodating chamber 320 having a semi-circular through hole 321 in the interior. The fixing base 32 is further bored with an insert hole 322 in the center. The blocking member 31 received in the accommodating chamber 320 of the fixing base 32 is formed with a semi-circular through hole 310 and has one side fixed with an insert rod 311 to be inserted through the insert hole 322 of fixing base 32. The regulating button 33 is assembled on the outer wall of the housing 1 and provided with a connecting rod 330 extending into the interior 11 of the housing 1 and having a lengthwise insert hole 331 for the insert rod 311 of the blocking member 31 to be inserted therein. Further, the housing 1 is bored with an exhaust hole 18 in the topside.

The holding tray 4 to be positioned in the accommodating groove 10 of the housing 1 is formed with two accommodating chambers 40, 41.

The water tank 5 positioned in the accommodating chamber 40 of the holding tray 4 has an inflow hole 50 bored in an upper side and an outflow hole 51 bored in a rear side and fitted with a sleeve 52 to be connected with the connecting pipe 13 of the accommodating groove 10 of the housing 1.

The cover plate 6 to be covered on the holding tray 4 is bored with an insert hole 60 aligned to the draining hole 12 at the bottom of the housing 1 and located on the accommodating chamber 41 of the holding tray 4.

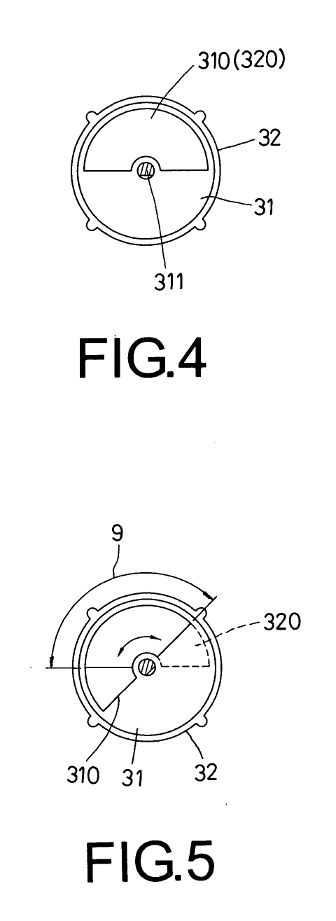

In use, as shown in FIGS. 1-5, firstly, water is poured into the water tank 5 through the inflow hole 50, and the cover plate 6 is covered on the holding tray 4. Next, the holding tray 4 and the cover plate 6 are together placed in the accommodating groove 10 of the housing 1, and the sleeve 52 of the water tank 5 is fitted with the connecting pipe 13, letting the insert hole 60 of the cover plate 6 aligned to the draining hole 12 at the bottom of the housing 1. Then, the water pumping motor 14 is started to pump the water in the water tank 5 to the water-feeding pipe 16, which will simultaneously guide the water to flow into the center hollow 20 of the electric heating tray 2. After the electric heating tray 2 is electrically powered, the water in the recessed opening 20 will be heated and converted into steam for steaming the food in the housing 1. Thus, the food steamed by the steam in the housing 1 can preserve its water contents and taste delicious. In the course of steaming, the steam in the housing 1 has to be released out in due time so as to regulate the inner pressure of the housing 1. The regulating button 33 can be turned for an angle to control the steam volume exhausted out of the housing 1. When the regulating button 33 is turned for an angle, the blocking member 31 will be actuated to rotate and for the same angle for controlling the steam volume exhausted, and when the semi-circular through hole 310 of the blocking member 31 completely matches with the semi-circular through hole 321 of the fixing base 32, the steam volume exhausted reaches a maximum, as shown in FIG. 4. Thus, the regulating button 33 can be turned for various angles to adjust the size of the common opening 9 formed by the through hole 310 of the blocking member 31 turned to open the through hole 321 of the fixing base 32 in various degrees for regulating steam volume exhausted out through the hole 321, as shown in FIG. 5. The steam in the housing 1 can be then exhausted out orderly through the exhaust passageway 17, the through hole 310 of the blocking member 31 and the through hole 321 of the fixing base 32 as well as the exhaust hole 18 at the upper side of the housing 1.

In addition, part of the steam in the roaster oven interior 11, after cooling, will be condensed into water drops dropping to the bottom of the housing 1 and then flow into the accommodating chamber 41 of the holding tray 4 through both the draining hole 12 at the bottom of the housing 1 and the insert hole 60 of the cover plate 6. When the water tank 5 is to be filled with water or when the water gathered in the accommodating chamber 41 is to be poured out, only draw out the holding tray 4 from the accommodating groove 10 at the bottom of the housing 1.

As can be understood from the above description, this invention has the following advantages.

1. Food steamed in the steam oven of this invention can preserve its moisture and cannot become dry and hard, making the steamed food tasty.

2. It is convenient to pour water into the water tank and clean the holding tray.

3. The steam volume exhausted out can be regulated by the regulating button.

While the preferred embodiment of the invention has been described above, it will be recognized and understood that various modifications may be made therein and the appended claims are intended to cover all such modifications that may fall within the spirit and scope of the invention.

What is claimed is:

1. A steaming structure for a steam oven comprising:
a housing provided with an accommodating groove in its bottom and bored with a draining hole in its interior communicating with said accommodating groove, said accommodating groove having its inner wall provided with a connecting pipe, said connecting pipe connected with a water-pumping motor, said housing further provided with an exhaust passageway at the inner upper side, and an exhaust hole bored in a topside;
said water-pumping motor having the other end connected with a duct that has the other end connected with a water feeding pipe inserted in said housing;
an electric heating tray positioned below said water feeding pipe in said housing and formed with a center hollow opening upward;
a holding tray received in said accommodating groove of said housing and formed with two accommodating chambers; and,
a water tank received in one of said two accommodating chambers and bored with an inflow hole in an upper wall and an outflow hole in a rear wall, said outflow hole assembled with a sleeve connected with said connecting pipe of said accommodating groove at the bottom of said housing.

2. The steam structure for a steam roaster oven as claimed in claim 1, wherein said regulating device is composed of a connecting base, a blocking member, a fixing base and a regulating button; said connecting base connected with one end of said exhaust passageway, said fixing base positioned at one side of said connecting base, said fixing base formed with an accommodating chamber having a through hole in the interior, said fixing base further bored with an insert hole in the center, said blocking member received in said accommodating chamber of said fixing base, said blocking member bored with a through hole and having one side fixed with an insert rod to be inserted through said insert hole of said fixing base, said regulating button assembled on the outer wall of said housing and provided with a connecting rod extending into the interior of said housing, said connecting rod of said regulating button bored with a lengthwise insert hole for said insert rod of said blocking member to be inserted therein.

3. The steam structure for a steam roaster oven as claimed in claim 1, wherein said holding tray is covered with a cover plate bored with an insert hole aligned to said draining hole at the bottom of said housing and located on the other of said accommodating chambers of said holding tray.
